(19) United States
(12) Patent Application Publication
(10) Pub. No.: US 2015/0046764 A1
(43) Pub. Date: Feb. 12, 2015

(54) RECORDING AND REPRODUCING APPARATUS

(71) Applicant: Kabushiki Kaisha Toshiba, Minato-ku (JP)

(72) Inventors: Kohsuke HARADA, Yokohama-shi (JP); Akihiro Yamazaki, Yokohama-shi (JP); Yosuke Kondo, Fujisawa-shi (JP); Kenji Yoshida, Kamakura-shi (JP); Kazuhito Ichihara, Kawasaki-shi (JP); Kazuto Kashiwagi, Yokohama-shi (JP)

(73) Assignee: Kabushiki Kaisha Toshiba, Minato-ku (JP)

(21) Appl. No.: 14/142,096

(22) Filed: Dec. 27, 2013

Related U.S. Application Data
(60) Provisional application No. 61/862,609, filed on Aug. 6, 2013.

(51) Int. Cl. G06F 11/07

(52) U.S. Cl. CPC G06F 11/0763
USPC 714/752

(57) ABSTRACT

According to one embodiment, a recording and reproducing apparatus includes a first masking unit configured to apply first bit masking to error correction code (ECC) encoded data using a bit sequence for masking, to generate a masked bit sequence to be recorded on a medium, and a de-masking unit configured to apply de-masking, using the bit sequence for masking, to a sequence of decision values based on a signal read from the medium to generate a sequence of de-masked decision values to be ECC decoded. The bit sequence for masking comprises an iteration of a fixed bit sequence of N (>1) bits. The bit de-masking is an inverse process corresponding to the first bit masking.

### CROSS-REFERENCE TO RELATED APPLICATIONS

This application claims the benefit of U.S. Provisional Application No. 61/862,609, filed Aug. 6, 2013, the entire contents of which are incorporated herein by reference.

### FIELD

Embodiments described herein relate generally to recording and reproduction or transmission and reception of information.

### BACKGROUND

Intersymbol interference may occur when information recorded in a storage medium (for example, a magnetic storage disk or an optical storage disc) is reproduced. Intersymbol interference may also occur when information transmitted via a wireless channel is received. Such intersymbol interference acts as noise, hindering the channel capacity of the storage medium or the wireless channel from being improved.

### BRIEF DESCRIPTION OF THE DRAWINGS

FIG. 1 is a diagram illustrating a recording and reproducing apparatus according to a first embodiment;

FIG. 2 is a block diagram illustrating the details of the recording and reproducing apparatus according to the first embodiment;

FIG. 3 is a diagram illustrating a first masking unit in FIG. 2;

FIG. 4 is a diagram illustrating masking carried out by the first masking unit in FIG. 2;

FIG. 5 is a diagram illustrating a de-masking unit in FIG. 2;

FIG. 6 is a diagram illustrating the de-masking unit in FIG. 2; and

FIG. 7 is a diagram illustrating a second masking unit in FIG. 2.

### DETAILED DESCRIPTION

In general, according to one embodiment, a recording and reproducing apparatus includes a first masking unit and a de-masking unit. The first masking unit applies first bit masking to error correction code (ECC) encoded data using a bit sequence for masking, to generate a masked bit sequence to be recorded on a medium. The de-masking unit applies bit de-masking, using the bit sequence for masking, to a sequence of decision values based on a signal read from the medium, to generate a sequence of de-masked decision values to be ECC decoded. The bit sequence for masking comprises an iteration of a fixed bit sequence of N (>1) bits. The bit de-masking is a reverse process corresponding to the first bit masking.

Elements that are identical or similar to corresponding described elements are denoted by identical or similar reference numerals, and description of these elements is basically omitted.

### First Embodiment

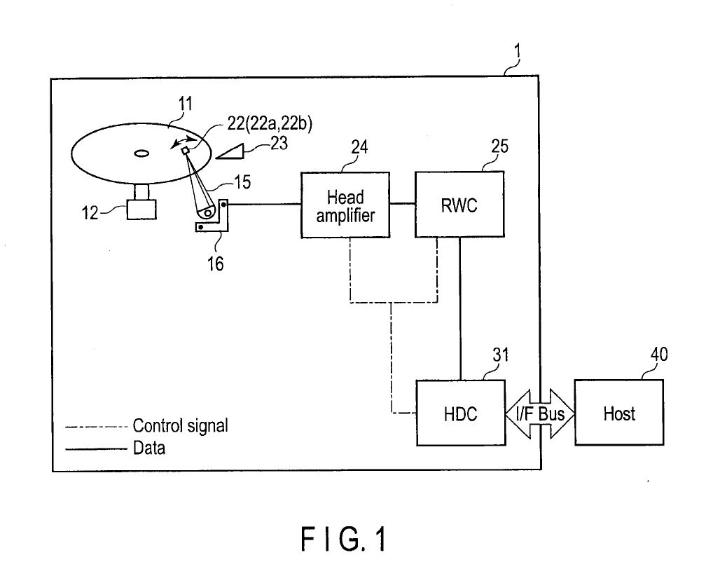

FIG. 1 illustrates a disk drive 1 serving as a recording and reproducing apparatus according to a first embodiment. The disk drive 1, for example, is a device that records information on a magnetic disk (disk medium) 11 through a magnetic read/write head 22 and reads a signal from the magnetic disk (disk medium) 11 through the magnetic read/write head 22 and, for example, is a magnetic disk drive (for example, a hard disk drive (HDD)). More specifically, the disk drive 1 includes the magnetic disk 11, a spindle motor 12, the magnetic read/write head 22, an actuator arm 15, a voice coil motor (VCM) 16, a ramp 23, a head amplifier 24, a read write channel (RWC) 25 and a hard disk controller (HDC) 31.

The magnetic disk 11 is rotated around a rotation axis at a predetermined rotation speed by the spindle motor 12.

The magnetic read/write head 22 writes/reads data into/from the magnetic disk 11 by using a recording head 22a and a reproducing head 22b included therein. In addition, magnetic read/write head 22 is moved in the radial direction (track width direction) of the magnetic disk 11 at the tip end of the actuator arm 15 by the voice coil motor 16. When the rotation of the magnetic disk 11 is being stopped or the like, the magnetic read/write head 22 is retracted on the ramp 23.

The head amplifier 24 amplifies a signal read from the magnetic disk 11 by the magnetic read/write head 22 and outputs the amplified signal, thereby supplying the amplified signal to the read write channel 25. In addition, the head amplifier 24 amplifies a signal used for writing data onto the magnetic disk 11, which has been supplied from the read write channel 25, and supplies the amplified signal to the magnetic read/write head 22.

The hard disk controller 31 performs control of data transmission and data reception with the host computer 40 through an I/F bus, and the like.

The read write channel 25 performs code modulation of data to be written onto the magnetic disk 11, which is supplied from the hard disk controller 31, and supplies the modulated data to the head amplifier 24. In addition, the read write channel 25 performs code demodulation of a signal that is read from the magnetic disk 11 and is supplied from the head amplifier 24 and outputs the demodulated signal to the hard disk controller 31 as digital data.

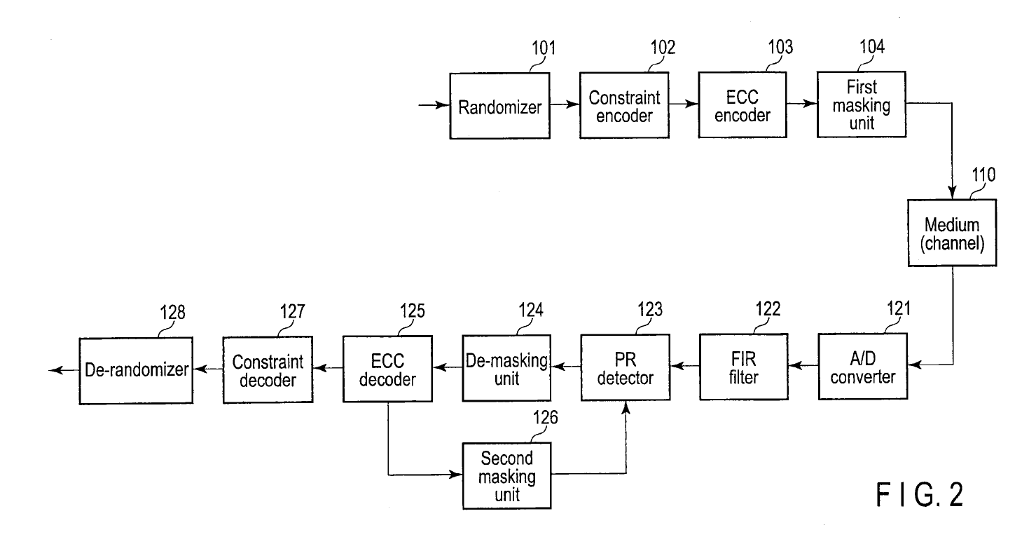

As illustrated in FIG. 2, the recording and reproducing apparatus according to the first embodiment comprises a randomizer 101, a constraint encoder 102, an error correction code (ECC) encoder 103, a first masking unit 104, a medium (or channel) 110, an analog-to-digital (A/D) converter 121, a finite impulse response (FIR) filter 122, a partial response (PR) detector 123, a de-masking unit 124, an ECC decoder 125, a second masking unit 126, a constraint decoder 127, and a de-randomizer 128.

The recording and reproducing apparatus in FIG. 2 corresponds to the read write channel 25 in FIG. 1 and peripheral components thereof. The recording and reproducing apparatus in FIG. 2 can be converted into a wireless communication apparatus (for example, a transmitter, a receiver, or a transceiver) by adding, deleting, or replacing functional units as necessary.

The randomizer 101 receives original user data. The randomizer 101 randomizes the original user data using a predetermined random bit sequence, to generate write user data. The randomizer 101 outputs the write user data to the constraint encoder 102.

The constraint encoder 102 receives the write user data from the randomizer 101. The constraint encoder 102 adds a synchronizing signal to the write user data to generate constraint encoded user data. The constraint encoder 102 outputs the constraint encoded user data to the ECC encoder 103.

The synchronizing signal is used to control operating timings for a phase locked loop (PLL). When the recording and reproducing apparatus in FIG. 2 is converted into a wireless communication apparatus, the constraint encoder 102 may be deleted.

The ECC encoder 103 receives constraint encoded data from the constraint encoder 102. The ECC encoder 103 ECC encodes the constraint encoded data to generate ECC encoded data. The ECC encoder 103 outputs the ECC encoded data to the first masking unit 104.

The ECC may be, for example, a Bose-Chaudhuri-Hocquenghem (BCH) code, or a low-density parity check (LDPC) code.

The first masking unit 104 receives the ECC encoded data from the ECC encoder 103. The first masking unit 104 applies bit masking to the ECC encoded data (that is, an input bit sequence) using a predetermined bit sequence (hereinafter referred to as a bit sequence of masking), to generate a masked bit sequence. The masked bit sequence is recorded in the medium 110.

The masking may be an exclusive OR operation between an input bit sequence and a bit sequence for masking. The bit sequence for masking may comprise, for example, an iteration of a fixed bit sequence of N (>1) bits. The fixed bit sequence is, for example, “10”, “01”, “1100”, “1001”, “0011”, or “0110”. The bit sequence for masking is desirably uncorrelated with channel characteristics.

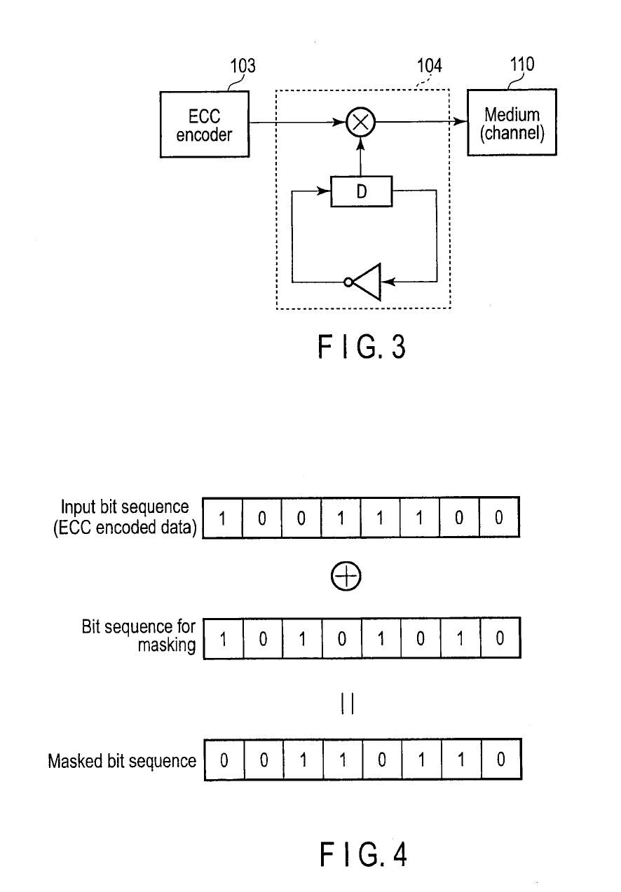

Specifically, the first masking unit 104 Illustrated in FIG. 3 may be adopted. The first masking unit 104 in FIG. 3 performs an exclusive OR operation between an input bit sequence and a bit sequence for masking to generate a masked bit sequence. The bit sequence for masking comprises an iteration of “10” (or “01”). In other words, the fixed bit sequence is one of “10” and “01”.

Hence, as illustrated in FIG. 4, the odd-numbered (or even-numbered) symbols of an input bit sequence are inverted, whereas the even-numbered (or odd-numbered) symbols are maintained (not inverted). The inversion of a symbol as used herein has the same meaning as that of bit flip.

The first masking unit 104 in FIG. 3 comprises an XOR gate, a delay element, and a NOT gate. A loop circuit comprising the delay element and the NOT gate generates an iterative sequence of “10” (or “01”) serving as a bit sequence for masking. The XOR gate performs an exclusive OR operation between an input bit sequence and the bit sequence for masking to output a masked bit sequence.

A precoder may be provided adjacent to and downstream of the first masking unit 104 in the apparatus. The precoder provides a masked bit sequence with inverse characteristics of the medium 110 to improve the channel capacity of the medium 110.

The medium 110 is of any type of medium that enables information to be recorded and reproduced. The medium 110 is, for example, a magnetic storage disk or an optical storage disc. When the recording and reproducing apparatus in FIG. 2 is applied to a wireless communication apparatus, the medium 110 may be interchanged with the channel 110.

The A/D converter 121 coverts an analog signal read from the medium 110 into a digital signal. The A/D converter 121 outputs the digital signal to the FIR filter 122.

The FIR filter 122 receives the digital signal from the A/D converter 121. The FIR filter 122 carries out filtering for band limitation on the digital signal to generate a filtered digital signal. The FIR filter 122 outputs the filtered signal to the PR detector 123.

The PR detector 123 receives the filtered signal from the FIR filter 122. PR detector 123 carries out PR symbol detection based on the filtered signal to calculate a decision value for each symbol. The PR detector 123 outputs a sequence of decision values to the de-masking unit 124. The symbol as used herein means each of the symbols forming a masked bit sequence to be read.

The PR symbol detection includes calculation of a branch metric using noise variance. The noise variance is pre-derived by the PR detector 123 through channel training. However, the above-described masking has been applied to the symbols intended for the PR symbol detection, and thus, the noise variance of the symbols may be different from a noise variance derived through channel training. Thus, the PR detector 123 may correct the noise variance by multiplying the noise variance by a weight coefficient. The use of the corrected noise variance allows a more appropriate branch metric to be calculated for the symbols with masking applied thereto. Consequently, the channel capacity can be improved.

The PR detector 123 may be designed to calculate a hard decision value for each of the symbols or to calculate a soft decision value for each of the symbols.

The hard decision value is “1” when the target symbol is determined to be likely to be “1”, and is “0” when the target symbol is determined to be likely to be “0”.

The soft decision values can be roughly divided into a first type (for example, a log likelihood ratio (LLR)) and a second type (a pair of probabilities (or a pair of log likelihoods) including a first probability (or a first log likelihood) of a target symbol being “0” and a second probability (or a second log likelihood) of a target symbol being “1”. The soft decision value of the first type has a positive value with an absolute value increasing consistently with the probability of the target symbol being “0” and has a negative value with an absolute value increasing consistently with the probability of the target symbol being “1”.

When the recording and reproducing apparatus is converted into a wireless communication apparatus, the PR detector 123 may be replaced with a convolutional decoder, for example, a Viterbi decoder.

Moreover, the PR detector 123 may cooperate with the ECC decoder 125 in carrying out turbo equalization. In this case, the PR detector 123 needs to receive a sequence of masked extrinsic values from the second masking unit 126 described below.

The de-masking unit 124 receives a sequence of decision values from the PR detector 123. The de-masking unit 124 applies bit de-masking to the sequence of decision values using a bit sequence for masking, to generate a sequence of de-masked decision values. The de-masking corresponds to an inverse process of the masking applied by the first masking unit 104 to ECC encoded data corresponding to a sequence of decision values. The de-masking unit 124 outputs a sequence of de-masked decision values to the ECC decoder 125.

The de-masking unit 124 needs to carry out appropriate de-masking in accordance with the form of the decision value.

When the decision value corresponds to a hard decision value, the de-masking unit 124 may carry out the same process as that executed by the first masking unit 104. For example, the de-masking may be an exclusive OR operation between an input bit sequence (that is, a sequence of decision values) and a bit sequence for masking.

Specifically, the de-masking unit 124 illustrated in FIG. 6 may be adopted. The de-masking unit 124 in FIG. 6 performs an exclusive OR operation between an input bit sequence and a bit sequence for masking to generate a sequence of de-masked decision values. The bit sequence for masking comprises an iteration of “10” (or “01”). In other words, the fixed bit sequence is one of “10” and “01”.

The de-masking unit 124 in FIG. 6 comprises an XOR gate, a delay element, and a NOT gate. A loop circuit comprising the delay element and the NOT gate generates an iterative sequence of “10” (or “01”) serving as a bit sequence for masking. The XOR gate performs an exclusive OR operation between an input bit sequence and the bit sequence for masking to output a sequence of de-masked decision values.

When the decision value corresponds to a soft decision value of the first type, the de-masking unit 124 may invert the sign of the decision value of each symbol inverted in the masking and maintain the sign of the decision value of each symbol maintained in the masking. For example, the de-masking unit 124 may invert the sign of a decision value when a value in the bit sequence for masking corresponding to the decision value is “1” and may maintain the sign of the decision value when the value in the bit sequence for masking is “0”.

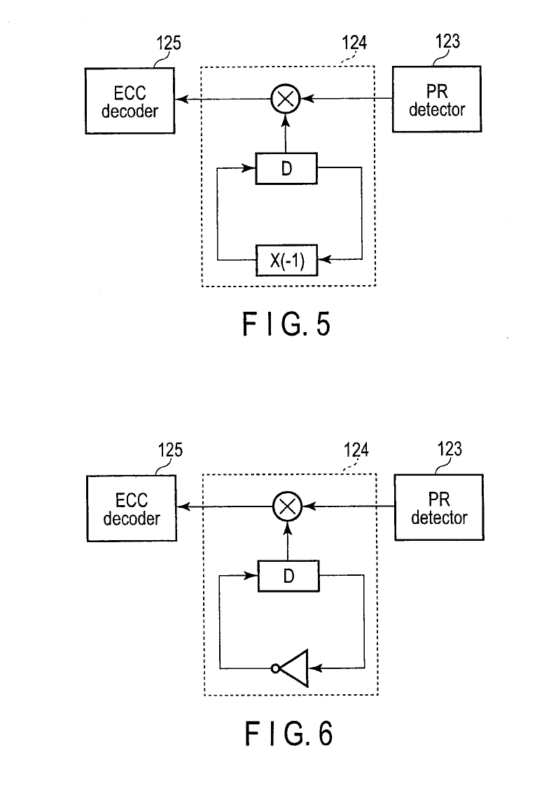

Specifically, the de-masking unit 124 illustrated in FIG. 5 may be adopted. The de-masking unit 124 in FIG. 5 multiplies each of the decision values by “−1” or “+1” (that is, inverts or maintains the sign) depends on the bit sequence for masking. The bit sequence for masking comprises an iteration of “10” (or “01”). In other words, the fixed bit sequence is one of “10” and “01”.

The de-masking unit 124 in FIG. 5 comprises a multiplier, a delay element, and a sign inverter. A loop circuit comprising the delay element and the sign inverter generates an iterative sequence of “−1, +1” (or “+1, −1”) corresponding to an iterative sequence of “10” (or “01”) serving as a bit sequence for masking. The multiplier multiplies a sequence of decision values by the repetitive sequence of “−1, +1” to output a sequence of de-masked decision values.

When the decision value corresponds to a soft decision value of the second type, the de-masking unit 124 may replace, for the decision value of each symbol inverted in the masking, the first probability (or the first log likelihood) with the second probability (or the second log likelihood), and the second probability (or the second log likelihood) with the first probability (or the first log likelihood). Such a manipulation may be referred to as replacement of the first probability (or the first log likelihood) with the second probability (or the second log likelihood). On the other hand, the de-masking unit 124 may maintain the first probability (or the first log likelihood) and the second probability (or the second log likelihood) for the decision value of each symbol maintained in the masking. For example, the de-masking unit 124 may replace the first probability (or the first log likelihood) with the second probability (or the second log likelihood) when a value in the bit sequence for masking corresponding to a decision value is “1” and may maintain the first probability (or the first log likelihood) and the second probability (or the second log likelihood) when the value in the bit sequence for masking is “0”.

In short, the de-masking unit 124 replaces or maintains the first probability (first log likelihood) and the second probability (second log likelihood) for each of the decision values depending on the bit sequence for masking, to generate a sequence of de-masked decision values.

The ECC decoder 125 receives the sequence of de-masked decision values from the de-masking unit 124. The ECC decoder 125 ECC decodes the sequence of de-masked decision values to generate an ECC decoded data. The ECC decoder 125 outputs the ECC decoded data to the constraint decoder 127. The ECC is the same as the ECC used by the ECC encoder 103.

Moreover, the ECC decoder 125 may cooperate with the PR detector 123 in carrying out turbo equalization. In this case, the ECC decoder 125 outputs a sequence of extrinsic values calculated during the ECC decoding to the second masking unit 126.

The second masking unit 126 receives the sequence of extrinsic values from the ECC decoder 125. The second masking unit 126 applies bit masking to the sequence of extrinsic values using a bit sequence for masking, to generate the sequence of masked extrinsic values. The masking corresponds to an inverse process of the de-masking applied by the de-masking unit 124 to the sequence of decision values corresponding to the sequence of extrinsic values. The second masking unit 126 outputs the sequence of masked extrinsic values to the PR detector 123. If the PR detector 123 and the ECC decoder 125 do not carry out turbo equalization, the second masking unit 126 may be deleted.

The second masking unit 126 needs to carry out appropriate masking in accordance with the form of the extrinsic value. The extrinsic values can be roughly divided into a first type (for example, a difference in LLR) and a second type (a pair of differences including a difference in the first probability (or the first log likelihood) and a difference in the second probability (or the second log likelihood).

When the extrinsic value corresponds to the first type, the second masking unit 126 may invert the side of the extrinsic value of each decision value inverted in the de-masking and maintain the sign of the extrinsic value of each decision value maintained in the de-masking. For example, the second masking unit 126 may invert the sign of an extrinsic value when a value in the bit sequence for masking corresponding to the extrinsic value is “1” and maintain the sign of the extrinsic value when the value in the bit sequence for masking is “0”.

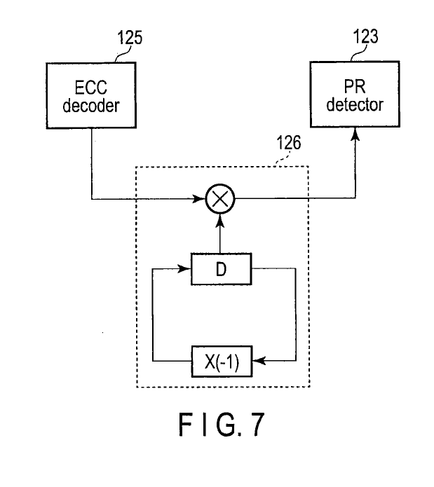

Specifically, the second masking unit 126 illustrated in FIG. 7 may be adopted. The second masking unit 126 in FIG. 7 multiplies each of the extrinsic values by “−1” or “+1” (that is, inverts or maintains the sign) depends on the bit sequence for masking. The bit sequence for masking comprises an iteration of “10” (or “01”). In other words, the fixed bit sequence is one of “10” and “01”.

The second masking unit 126 in FIG. 7 comprises a multiplier, a delay element, and a sign inverter. A loop circuit comprising the delay element and the sign inverter generates an iterative sequence of “−1, +1” corresponding to an iterative sequence of “10” (or “01”) serving as a bit sequence for masking. The multiplier multiplies a sequence of extrinsic values by the repetitive sequence of “−1, +1” to output a sequence of masked extrinsic values.

When the extrinsic value corresponds to the second type, the second masking unit 126 may replace, for the extrinsic value of each decision value replaced in the de-masking, the difference in the first probability (or the first log likelihood) with the difference in the second probability (or the second log likelihood), and the difference in the second probability (or the second log likelihood) with the difference in the first probability (or the first log likelihood). Such a manipulation may be referred to as replacement of the difference in the first probability (or the first log likelihood) with the difference in the second probability (or the second log likelihood). On the other hand, the second masking unit 126 may maintain the difference in the first probability (or the first log likelihood) and the difference in the second probability (or the second log likelihood) for the extrinsic value of each decision value maintained in the de-masking.

In short, the second masking unit 126 replaces or maintains the difference in the first probability (first log likelihood) and the difference in the second probability (second log likelihood) for each of the decision values depending on the bit sequence for masking, to generate a sequence of masked extrinsic values.

The constraint decoder 127 receives ECC decoded data from the ECC decoder 125. The constraint decoder 127 deletes the synchronizing signal from the ECC decoded data to generate readback user data. The constraint decoder 127 outputs the readback user data to the de-randomizer 128.

The synchronizing signal is added by the constraint encoder 102 and used to control operating timings for the PLL. The de-randomizer 128 receives the readback user data from the constraint decoder 127. The de-randomizer 128 de-randomizes the readback user data using a predetermined random bit sequence, to restore the original user data. The predetermined random bit sequence is the same as the random bit sequence used by the above-described randomizer 101.

As described above, the recording and reproducing apparatus according to the first embodiment applies bit masking to ECC encoded data to generate a masked bit sequence, and records the masked bit sequence in the medium. The recording and reproducing apparatus applies bit de-masking to a sequence of de-masked decision values based on a signal read from the medium, to generate a sequence of de-masked decision values, and ECC decodes the sequence of de-masked decision values. The de-masking corresponds to the inverse process of the masking applied, during recording, to the ECC encoded data corresponding to the sequence of decision values. Thus, according to the recording and reproducing apparatus, adoption of the appropriate bit sequence for masking (for example, an iterative sequence of one of “10” and “01”) allows the adverse effect of intersymbol interference to be effectively suppressed. Hence, the channel capacity can be improved.

Moreover, in the recording and reproducing apparatus, the functional units other than the first masking unit, the de-masking unit, and the second masking unit need not have the operations thereof changed depending on whether or not the first masking unit, the de-masking unit, and the second masking unit are present.

At least a part of the processing according to the above-described embodiments can be implemented by using a general-purpose computer as basic hardware. A program implementing the processing according to the embodiments may be stored in a computer readable storage medium for provision. The program is stored in the storage medium as a file in an installable format or in an executable format. The storage medium may be a magnetic disk, an optical disc (CD ROM, CD-R, DVD, or the like), a magneto-optical disk (MO or the like), a semiconductor memory, or the like. Any storage medium may be used provided that a program can be stored in the storage medium and that the computer can read data from the storage medium. Furthermore, a program implementing the processing according to the embodiments may be stored on a computer (server) connected to a network such as the Internet and downloaded into a computer (client) via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording and reproducing apparatus comprising:
a first masking unit configured to apply first bit masking to error correction code (ECC) encoded data using a bit sequence for masking, to generate a masked bit sequence to be recorded on a medium; and
a de-masking unit configured to apply de-masking, using the bit sequence for masking, to a sequence of decision values based on a signal read from the medium to generate a sequence of de-masked decision values to be ECC decoded,
wherein the bit sequence for masking comprises an iteration of a fixed bit sequence of N (>1) bits, and
the bit de-masking is an inverse process corresponding to the first bit masking.

2. The apparatus according to claim 1, wherein the first bit masking is an exclusive OR operation between the ECC encoded data and the bit sequence for masking.

3. The apparatus according to claim 1, wherein the fixed bit sequence is one of “10” and “01”.

4. The apparatus according to claim 3, wherein the first masking unit comprises:
a loop circuit including a delay element and a NOT gate, the loop circuit generating the bit sequence for masking; and
an XOR gate which carries out exclusive OR operation of the ECC encoded data and the bit sequence for masking to output the masked bit sequence.

5. The apparatus according to claim 1, wherein each of the decision values corresponds to a hard decision value, and
the de-masking unit inverts or maintains each of the decision values depending on the bit sequence for masking.

6. The apparatus according to claim 5, wherein the bit de-masking is an exclusive OR operation between the sequence of decision values and the bit sequence for masking.

7. The apparatus according to claim 5, wherein the fixed bit sequence is one of “10” and “01”.

8. The apparatus according to claim 7, wherein the de-masking unit comprises:
a loop circuit including a delay element and a NOT gate, the loop circuit generating the bit sequence for masking; and
an XOR gate which carries out exclusive OR operation of the sequence of decision values and the bit sequence for masking to output the sequence of de-masked decision values.

9. The apparatus according to claim 1, wherein each of the decision values corresponds to a log likelihood ratio (LLR), and
the de-masking unit inverts or maintains a sign of each of the decision values depending on the bit sequence for masking.

10. The apparatus according to claim 9, wherein the fixed bit sequence is one of “10” and “01”.

11. The apparatus according to claim 10, wherein the de-masking unit comprises:
a loop circuit including a delay element and a sign inverter, the loop circuit generating an iterative sequence of one of “−1, +1” and “+1, −1”; and
a multiplier which multiplies the sequence of decision values by the iterative sequence to output the sequence of de-masked decision values.

12. The apparatus according to claim 1, wherein each of the decision values corresponds to a pair of probabilities including a first probability of a target symbol being “0” and a second probability of the target symbol being “1”,
the de-masking unit replaces or maintains the first probability and the second probability for each of the decision values depending on the bit sequence for masking.

13. The apparatus according to claim 1, further comprising:
a second masking unit configured to apply second bit masking, using the bit sequence for masking, to a sequence of extrinsic values generated by ECC decoding carried out on the sequence of de-masked decision values, to generate a sequence of masked extrinsic values for turbo equalization, and
the second bit masking is an inverse process corresponding to the bit de-masking.

14. The apparatus according to claim 13, wherein each of the extrinsic values corresponds to a difference in log likelihood ratio (LLR), and
the second masking unit inverts or maintains a sign of each of the extrinsic values depending on the bit sequence for masking.

15. The apparatus according to claim 14, wherein the fixed bit sequence is one of “10” and “01”.

16. The apparatus according to claim 15, wherein the second masking unit comprises:
a loop circuit including a delay element and a sign inverter, the loop circuit generating an iterative sequence of one of “−1, +1” and “+1, −1”; and
a multiplier which multiplies the sequence of extrinsic values by the iterative sequence to output the sequence of masked extrinsic values.

17. The apparatus according to claim 13, wherein each of the extrinsic values corresponds to a pair of differences including a difference in a first probability of a target symbol being “0” and a difference in a second probability of the target symbol being “1”,
the second masking unit replaces or maintains the difference in the first probability and the difference in the second probability for each of the extrinsic values depending on the bit sequence for masking.
